(19) United States
(12) Patent Application Publication
(10) Pub. No.: US 2011/0138708 A1
(43) Pub. Date: Jun. 16, 2011

(54) Superimposed Computer Room Building and Process for Cooling this Building

(75) Inventors: Mathieu CHAZELLE, Montreuil (FR); Simon PALLUBICKI, Montreuil (FR); Brice PIECHACZYK, Montreuil (FR); Laurent POMMIER, Paris (FR); Bernard CAZERES, Montreuil (FR); Nicolas AUBE, Paris (FR)

(73) Assignees: ENIA ARCHITECTES, Montreuil (FR); CELESTE MANAGEMENT, Torcy (FR)

(21) Appl. No.: 12/965,120

(22) Filed: Dec. 10, 2010

(30) Foreign Application Priority Data
Dec. 11, 2009 (FR) FR0906019

(51) Int. Cl. E04F 17/04; G05D 23/13; E04B 1/00

(52) U.S. Cl. 52/173.1; 236/12.14; 52/236.3; 52/302.1

(57) ABSTRACT

Building comprising at least two vertically superimposed computer rooms 2, 3, 4, 5 each limited by a peripheral wall 6 and separated from each other by an intermediate floor 7 and which each contain computer cabinets 11 for computer or electronic equipment 25. The building is characterised in that: each computer room 2, 3, 4, 5 comprises at least one interior wall 10 formed in part or less by the computer cabinets 11 and which separates the interior volume of each computer room into a hot zone Zc and a cold zone Zf, since the air cannot flow between the hot zone Zc and the cold zone Zf without passing through the computer cabinets 11; each intermediate floor 7, 8, 9 is perforated to allow free circulation of air, all cold zones Zf are superimposed and forming a supply column of fresh air Cₐ and all the hot spots are superimposed forming an exhaust column of hot air Cₑ; the floors 7, 8, 9, the perimeter walls 6 and interior walls 10 are adapted to prevent a direct flow of air between the supply column Cₐ and the exhaust column Cₑ, and the building comprises fresh air means 20, 30 in the supply column Cₐ and means for evacuating 23, 30 hot air from the exhaust column Cₑ.

This application claims priority from French Patent Application No. 09/06019 filed Dec. 11, 2009, the disclosure of which is incorporated herein by reference.

### FIELD OF THE INVENTION

This invention relates to the technical field of data centres, which comprise, on one hand, at least a computer room inside which are arranged servers or other computer or electronic equipment, and means of connection associated communications networks and, on the other hand, means of supplying energy to the servers and means of cooling the computer room. The invention relates more particularly to the field of buildings hosting such data centres.

### BACKGROUND OF INVENTION

An essential element in the design of these buildings lies in the implementation of systems for cooling servers insofar as hardware manufacturers require relatively low temperature ranges for rooms housing the servers, to maintain the contractual warranty for the equipment. In addition, air conditioning systems for computer rooms are the second biggest energy consumer after the computer systems themselves in the operation of data centres. Thus to reduce the energy impact of a data centre, a possible way to make economies is finding a way to optimise cooling systems for computer rooms both with regard to air conditioning and treatment in rooms and the air circuit of the air in the room.

To simplify the air circuit, an international application WO 02/052 107 has proposed to fit the computer room in a warehouse and place the hardware and secure electrical supply systems and associated connection means to communications networks, on different superimposed mezzanines with a grid floor to allow a free flow of air around the equipment to be cooled. This international application also proposes to ensure air circulation inside the computer room by natural convection, on one hand, by fitting air intakes at the low parts of the walls of the warehouse, and air evacuations on the roof. Such a conception of the computer room however has the disadvantage of requiring the use of a large volume for a small number of servers and does not provide good control of air temperature at the server level.

To address this problem of controlling the air temperature at the server level, a Japanese application JP2009-79890 has proposed a computer room in which the receiving server cabinets are arranged in two rows back to back to define a row of fresh air intakes between them, closed by a ceiling and flexible doors that isolates it from the rest of the computer room. The computer room also comprises a raised floor, open at the level of the corridor for bringing fresh air. The computer room air conditioning is then ensured by a system operating in a closed circuit by sucking air from the room outside the corridor for bringing fresh air and from the computer cabinets to reject it back into the raised floor. Thus, the fresh air is forced to pass through the computer cabinets before being cooled and recycled. Such a system allows good control of air temperature at the level of the servers insofar as it avoids mixing cooled air with hot air from the servers, unlike the system proposed by the International Application WO 02/052107. However, the Japanese system has the disadvantage of requiring the use of an air conditioning system and a raised floor for each computer room and causing strong air pressure drops considering the recycled air circuit.

There is therefore a need for a new type of building including computer rooms that allow optimisation of the air conditioning system particularly with regard to the air circuit and a reduction in energy consumption for air conditioning in computer rooms.

### SUMMARY OF THE INVENTION

To reach these goals, the invention relates to a building comprising at least two superimposed computer rooms, each limited by a peripheral wall and separated from each other by an intermediate floor and which each contain computer cabinets for computer or electronic equipment. According to the invention, this building is:
each computer room including at least one interior wall that is formed in part or less by the computer cabinets and which separates the interior volume of each computer room into a hot zone and a cold zone, since the air cannot flow between the hot zone and the cold zone without passing through the computer cabinets,
the hot and respectively cold zones are stacked one floor above the other,
each intermediate floor is perforated to allow free circulation of air, on the one hand, between the superimposed hot zones, and, on the other hand, between the superimposed cold zones, all superimposed cold zones forming a supply column of fresh air and all the superimposed hot zones forming an exhaust column of hot air,
the floors, the perimeter walls and interior walls are adapted to prevent a direct flow of air between the supply column and the exhaust column,
and the building comprises means for providing fresh air in the supply column and means for evacuating hot air from the exhaust column.

The design of the building according to the invention for defining a supply column and an exhaust column common to all computer rooms provides an air circuit causing very low pressure drops compared with known systems. In addition, the circulation of air between the supply column and the exhaust column is mainly or exclusively through the computer cabinets, so there is no uncontrolled mixing between cool air and hot air and it is possible to have better control over the temperature of fresh air supplied to computer or electronic systems.

According to the invention, the building including the computer rooms is not necessarily a building dedicated solely to housing a data centre, but may also comprise rooms for various purposes such as for example rooms for offices, meetings, catering or other. In addition, the building according to the invention is not necessarily a new building but may also be an existing building that has been modified to incorporate superimposed computer rooms in accordance with the invention. Moreover, the computer rooms of a building according to the invention do not all necessarily have the same surface area, or the same geometric configuration, the essential thing being that they are separated by perforated floor allowing a free flow of air between the cold zones and the hot zones, provided that the cold zones and hot zones do not necessarily all have an identical form.

In accordance with the invention, a perforated floor should be understood as a floor able to let air through whilst allowing operators to stand on it safely. A perforated floor according to the invention may for example comprise solid or closed areas associated with open areas. A perforated floor according to the invention can also be formed by a lattice or grating, metal for example but exclusively, allowing a free flow of air through almost its entire surface. Thus, it is possible to obtain a perforated floor with a opening coefficient of over 40% or 80% resulting in very low pressure drops.

Of course, according to the invention, the computer rooms and cold and hot zones installed can also have substantially similar shapes from one room to another. Thus, according to a form of construction of a building according to the invention:
the peripheral walls of the computer rooms are superimposed and form a part of the building structure,
and the interior walls are superimposed from one computer room to the other.

Such a way of constructing the building makes it possible to optimise the air circulation within the supply and exhaust columns by reducing pressure drops and dead zones.

According to one characteristic of the invention, the computer cabinets are constructed so as to emphasise the passage of air from the cold zone to the corresponding hot zone by the parts of the cabinets containing electronic equipment and, to limit the passage of air through the empty parts of the cabinets as much as possible. To this end, each computer cabinet may comprise partitions and/or at least partly removable partitions suited for obstructing the free flow of air in parts of the cabinet without computer hardware or electronics.

According to the invention, the airflow inside the computer cabinets may simply result from a difference in pressure between the supply column and the exhaust column. However, the air circulation inside the computer cabinets can also be induced. For this purpose, the building according to the invention may comprise computer hardware or electronics disposed in at least one computer cabinet and adapted to draw in fresh air at a side facing the corresponding cold zone and to pump out warm air at a side facing the corresponding hot zone.

According to the invention, the cold and hot zones of each computer room may have equal or different surface areas. In a form of embodying the invention, the computer cabinets are usually designed so that the hardware are inserted or removed from the front in the cold zone, with each computer room fitted out so that the surface, measured at floor level of each cold zone is greater than or equal to the surface area, measured at floor level, of the corresponding hot zone.

According to a form of embodying the invention aiming towards optimising the energy performance of the building in terms of air conditioning computer rooms, the building has at least one staircase and/or lift access to the computer rooms fitted outside the computer rooms. Thus, it is possible to limit the volume of the computer rooms to only the volume required for storage of computer cabinets and interventions, in good working conditions, on the electronic or computer equipment they contain.

According to the invention, the fresh air intake and hot air exhaust is possible in any appropriate way.

Thus, according to a form of embodying the invention, the means of bringing fresh air and exhausting hot air comprise fresh air and hot air pipes connected to at least one air conditioning and/or air treatment installation.

According to a variation on this embodiment, the building then comprises at least below the lowest computer room:
a fresh air supply chamber which is separated from the cold area of the lowest room by a perforated floor allowing free air circulation and is connected to the air conditioning and/or air treatment installation,
a hot air exhaust chamber which is separated from the hot area of the lowest room by a perforated floor allowing free air circulation and is connected to the air conditioning and/or air treatment installation.

In the framework of this first embodiment variation, the air conditioning and/or air treatment installation may be located on the ground and/or in the basement. Thus, it is not necessary to size the building structure so that it can in height withstand the heavy load of the air conditioning and/or air treatment installation.

According to a second variation on this embodiment, the building comprises, at the level or above the highest computer room, at least:
a fresh air supply chamber which is separated from the cold area of the highest room by a perforated floor allowing free air circulation and is connected to the air conditioning and/or air treatment installation,
a hot air exhaust chamber which is separated from the hot area of the highest room by a perforated floor allowing free air circulation and is connected to the air conditioning and/or air treatment installation.

In the framework of this second variant, the air conditioning and/or air treatment installation may be located above or at the level of the highest computer room. Thus, it is possible to use natural convection within the supply and exhaust columns to contribute to air circulation in them.

To facilitate the circulation of air through the computer cabinets, the air conditioning and/or air treatment installation may be adapted to place the fresh air supply column under pressure and the hot air exhaust under negative pressure.

According to the invention, the hot air exhaust can also be provided by natural convection within the exhaust column. Thus, according to another variation of the embodiment, the means for evacuating hot air comprises at least one outlet open to the outside at the hot zone of the highest computer room.

Similarly, air from outside may not come from an air conditioning installation adjusting its temperature. For this purpose, according to another variation of fitting out the building, the means of bringing fresh air in comprise at least one exterior air intake vent at the cold zone level of the lowest computer room. In this case the circulation of air can be induced by a blower drawing air from the exhaust column. It should be noted that each entry and/or exit vent may be blocked by at least one movable flap allowing the degree of opening to be controlled.

According to the invention, the building air supply and exhaust can also be provided by natural convection without recourse to an air conditioning installation. For this purpose, according to another embodiment variation, the building comprises both inlet and outlet vents that can be fully or partially closed by movable flaps.

In addition, means for filtering the air before it enters the supply column could be provided at the level of the air intake vents, upstream or downstream.

In an embodiment designed to promote convection phenomena within the building according to the invention, each computer room has a height of 2 to 3 m and the building comprises at least four floors of computer rooms.

The invention also relates to a temperature regulating process for computer rooms of a building according to the invention. Such a regulation process is characterised in that it notably comprises:
in an operating mode, called winter, when the outside air is at a temperature less than or equal to a limit or maximum recommended temperature, implementing the following steps:
   evacuating part of the hot air from the hot air column to the outside
   taking outside air and mixing it with the remaining part of the hot air from the exhaust column to get fresh mixed air at a temperature within the recommended temperature range,
   supplying the supply column with the mixed fresh air obtained,
in a operation mode, called mid-season, when the outside air is at a temperature above the limit or maximum recommended temperature and lower than the temperature of the air coming out of the computer or electronic equipment, implementing the following steps:
   evacuating at least part of the hot air from the hot air column to the outside,
   taking outside air and mixing it as needed with the remaining part of the hot air from the exhaust column to get fresh mixed air,
   cooling the outside air or mixed air to obtain fresh air at a temperature within the recommended temperature range,
   supplying the supply column with the mixed fresh air obtained,
in a operation mode, called summer, when the outside air is at a temperature above the temperature of the air coming out of the computer or electronic equipment, implementing the following steps:
   completely recycling the hot air from the hot air column,
   cooling the recycled hot air to obtain recycled air at a temperature within the recommended temperature range,
   supplying the supply column with the recycled fresh air obtained.

In a variant of implementing the mid-season operation mode, the air from the exhaust column is completely vented to the outside and all air blown into the supply column is from the outside chilled and/or treated air. In this operation variant, hot air is preferably but not exclusively evacuated through the high exhaust vents to take advantage of natural convection.

According to one form of implementation, this process comprises a so-called economic mode to ensure the supply of air from the intake column and exhaust hot air from the exhaust column at least partly by natural convection by controlling the opening of inlet and outlet flaps.

In an alternative implementation, this method comprises a step of checking and adjusting the humidity of the air supplied to the supply column. The method may also comprise a step of filtering the air supplying the supply column.

The invention also concerns a process for regulating the temperature of the computer rooms, consisting of ensuring the supply of air from the supply column and exhaust hot air from the exhaust column at least partly by natural convection. The method may also comprise a step of filtering the air before its admission into the supply column.

Of course, the different variations and embodiments of the invention can be associated with each other in various combinations to the extent they are not incompatible or mutually exclusive.

Moreover, various other characteristics of the invention emerge from the description referred to in the appendix with drawings illustrating non-limiting forms of embodiment of a building with superimposed computer rooms in accordance with the invention.

### BRIEF DESCRIPTION OF THE DRAWINGS

FIG. 1 is a partially exploded view of a building, according to the invention, including vertically superimposed computer rooms.

FIG. 2 is a plan view of a floor of the building shown in FIG. 1, with a computer room, with the floors of the building with computer room all having substantially the same configuration.

FIG. 3 is a cross section view of an embodiment of a computer cabinet constituting of an inner wall of a computer room of the building shown in FIG. 1.

FIG. 4 is a plan view of a floor of a building according to another embodiment of the invention.

### DETAILED DESCRIPTION OF THE INVENTION

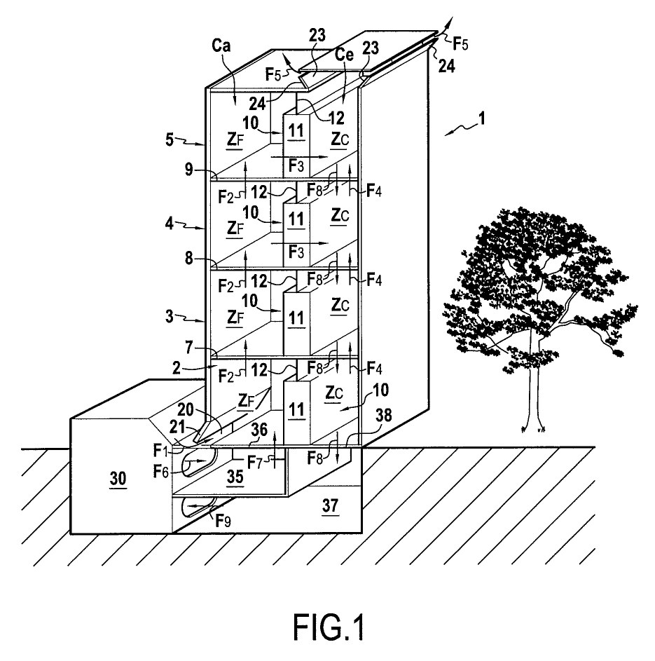

A building according to the invention, as shown in FIG. 1, 2 and generally designated by reference 1, comprises at least two and, according to the example in FIG. 1, four superimposed computer rooms 2, 3, 4, 5, on the understanding that building 1 could comprise more than four superimposed computer rooms. Each computer room is limited by a peripheral wall 6 which, in the example shown, is common to all computer rooms and forms an outer load-bearing wall of building 1. Thus, in this case, all the computer rooms 2, 3, 4, 5 have the same shape and the same inside surface area. Computer rooms 2, 3, 4 and 5 are also separated from each other by intermediate floors 7, 8, 9.

Each computer room also comprises an inner wall 10 which is partly formed by the juxtaposition of the computer cabinets 11 attached to each other. The inner wall 10 of each computer room is also formed by a top panel 12 which is interposed between the computer cabinets 11 and the ceiling of the corresponding computer room. The inner wall 10 also comprises a side panel 13 interposed between an end computer cabinet and the peripheral wall 6. The inner wall 10 thus limits a cold area Zf and a hot zone Zc. In the example shown, the side panel 13 comprises an inside door 14 allowing access to the hot zone Zc from the cold zone Zf while access to inside the computer room is by an exterior door 15 which is fitted in the peripheral wall 6 to open into the cold zone Zf. The outside door 15 is served, from an outside landing 16 by a staircase 17 and a lift 18 both located outside the computer rooms 2 to 5.

Each inner wall 10 is designed so that air circulation, between the corresponding cold Zf and hot Zc areas, happens mainly or even exclusively through the computer cabinets 11. The space between the computer cabinets 11 will be non-existent or closed.

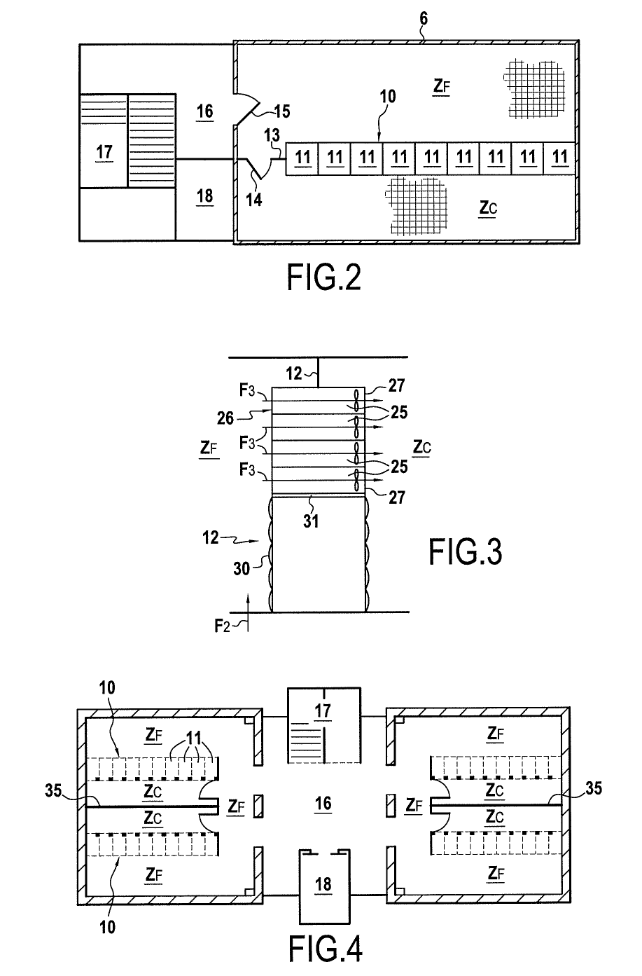

According to an essential characteristic of the invention, each intermediate floor 7, 8, 9 is perforated to allow free air circulation between the cold zones Zf and the hot zones Zc. In the example shown, the perforated parts of each intermediate floor are embodied by means of a sheet metal grating partially illustrated in FIG. 2. According to the example shown, the entire surface of the intermediate floor is formed by the grating which gives a higher aperture ratio of more than 80%. The part of the floor located at the level of computer cabinets 11 will be closed to prevent direct circulation of air between the corresponding hot Zc and cold Zf zones.

The use of the perforated intermediate floors allows all the superimposed cold areas Zf to form a supply column Cₐ whilst the superimposed hot zones Zc form an exhaust column Cₑ as will emerge as a result from the following.

The air conditioning of superimposed computer rooms 2 to 5 and therefore the cooling of electronic or computer equipment placed in the cabinets 11 can then be achieved in at least two ways.

The most economical way to achieve this cooling with a minimum expenditure of energy is to use natural convection. For this purpose, at least one air intake vent 20 is arranged in the peripheral wall of the cold zone Zf of the lowest computer room 2 which, in the example shown, is open to the outside and controlled by a movable flap 21 for the opening to be adjusted. Furthermore, at least one and, according to the illustrated example, two air exhaust vents 23 are arranged in the ceiling of the hot zone Zc of the highest computer room 5, which are open to the outside and controlled by a movable flap 24 for the opening to be adjusted. The intake vent 20 then constitutes the means of bringing fresh air while the outlet vents 23 constitute means for evacuating hot air.

The air circulation, in this configuration of the building according to the invention, is as follows.

The outdoor air enters the lowest computer room 2 by the air intake vent 20, as indicated by the arrow F1 and rises in the supply column through the intermediate floors 7 to 9 as shown by the arrows F2. Then cool air goes through the computer cabinets as shown by the arrows F3. Inside the computer cabinets, the air is heated on contact with the electronics or computer 25 inside.

In this regard, it should be noted that each piece of computer equipment 25 is arranged in the cabinets so that the ventilation system, which may equip it, induces suction of air from one side 26 turned towards the cold zone Zf and a discharge of air through a side 27 facing the hot zone Zc. In addition, to prevent fresh air passing through the computer equipment 25, each cabinet 11 preferably comprises partitions 30 and removable partitions 31 obstructing the circulation of air in the empty parts of each computer cabinet 11.

After passing through the computer cabinets 11, the hot air is in the hot areas Zc and rises in the evacuation column Cₑ under the effect of natural convection through the intermediate floors 7 to 9 as shown by the arrows F4, then to be discharged to the outside by vents 23 as shown by the arrows F5.

It should be noted that in a preferred embodiment, but not strictly necessary, to promote the chimney effect within the evacuation column Cₑ, the building shall comprise at least four floors of superimposed computer rooms 2 to 5 each with a height of 2 to 3 m.

Of course, natural convection is not the only possible way of cooling the building 1 according to the invention.

Thus, an installation 30 for air conditioning and treatment can also be implemented to ensure supply of fresh air, its filtering and discharge of hot air. The means of bringing fresh air then comprise, in the example shown, a chamber 35 for fresh air intake below the cold zone Zf of the lowest computer room 2. This fresh air chamber 35 is then separated from the cold zone Zf by a perforated floor 36 formed in the same way as the intermediate floors 7 to 9. The intake chamber 35 is then connected to the installation 30 either directly or through pipes or ventilating ducts.

Similarly, the means for evacuating the hot air then comprise an evacuation and/or recycling chamber of hot air 37 located below the hot zone Zc of the lowest computer floor 2 from which it is separated by a perforated floor 38 formed in the same way as the intermediate floors 7 to 9. The evacuation and/or recycling chamber 37 is then connected to the installation 30 either directly or through pipes or ventilating ducts. Of course, the intake chamber 35 and the exhaust and/or recycling chamber 37 and any associated pipes or ducts are isolated or separated from each other.

When the air conditioning 30 is used, the flaps 21 and 24 may be closed. Fresh air is then supplied by the 30 by being blown into the intake chamber 35 as shown by arrow F6 then to cross the floor 36 as indicated by the arrow F7. Cool air then continues its path as described above and indicated by arrows F2 and F3. Once in the evacuation column Cₑ the air can be sucked downwards and follow the path indicated by arrows F8 to enter the evacuation and/or recycling chamber 37 from which it is drawn by the installation 30 as shown by arrow F9. The air in the exhaust column may also be discharged upwards and follow the path indicated by arrows F4 and F5 to be evacuated completely or partially through the vents 23.

In a preferred embodiment, but not strictly necessary, intended to reduce as much as possible the energy consumption for the air conditioning of computer rooms, the installation 30 will be designed to switch automatically, depending on external conditions, to an operating mode selected from three operating modes called winter, mid-season and summer.

Thus, when the outside air is at a temperature less than or equal to a limit or maximum recommended temperature, the installation switches into the winter operation mode. This maximum or limit temperature generally depends on hosted computer or electronic equipment manufacturers' recommendations or the choice of the building operator according to the invention. The temperature limit may be selected at 23° C., for example but not exclusively. In winter operation mode, the installation 30 then evacuates part of the hot air from the hot air column to the outside. Simultaneously, the installation 30 takes outside air and mixes it with the remaining part of the hot air from the exhaust column to get fresh mixed air at a temperature within the temperature range recommended by manufacturers of computer or electronic equipment placed in the cabinets 11. The installation 30 then blows in fresh mixed air obtained in the supply column. The recommended temperature range may also be determined by the building operator and may, for example but not exclusively, be chosen as the range of 17° C. to 23° C.

When the outside air is at a temperature above the limit or maximum recommended temperature, the temperature of the air coming out of the computer or electronic equipment, generally but not exclusively above 30° C., the installation 30 goes into a possible variant of the mid-season mode of operation, implementing the following steps:
evacuating the hot air from the hot air column to the outside,
taking outside air,
cooling the outside air to obtain fresh air at a temperature within the recommended temperature range,
supplying the supply column with the mixed fresh air obtained.

In this mid-season operation variant, hot air is preferably but not exclusively evacuated through the vents 23 to take advantage of natural convection and thus reduce the energy consumption related to air blowing and/or suction.

When the outside air is at a temperature above the temperature of the air coming out of the computer or electronic equipment, the installation 30 goes into the summer operating mode. In the summer mode, the air circulates in closed circuit in the computer rooms and air conditioning installation 30. Thus, it completely recycles hot air from the of hot air column, cools it to obtain a recycled air at a temperature within the recommended temperature range, and finally supplies the supply column Cₐ with the fresh recycled air obtained.

It should be noted that when an air conditioning installation 30 is implemented, it may also be equipped with means for controlling the humidity of the air blown into the supply column Cₐ.

Moreover, in the case of implementing an air conditioning installation 30, the natural convection mode can be used in case of complete malfunction of the air conditioning installation 30. Of course, a building according to the invention may also be devoid of intake 20 and outlet 23 vents allowing its ventilation by natural convection.

Furthermore, it should be noted that the building and computer rooms are not necessarily of a shape as described in connection with FIGS. 1 and 2. Thus FIG. 4 shows a floor of a building according to the invention which comprises two computer rooms on each floor separated by a landing 16. Moreover, according to this example, the inner wall 10 of each computer room is formed by two rows of computer cabinets 11 placed back to back and separated by an intermediate wall 35 able to support the power supply wiring.

Obviously, various modifications may be made to the building and the process according to the invention within the framework of the appended claims.

1. Building comprising at least two vertically superimposed computer rooms each limited by a peripheral wall and separated from each other by an intermediate floor (7) and which each contain computer cabinets for computer or electronic equipment (25), building wherein:
each computer room comprises at least one interior wall formed in part or less by the computer cabinets and which separates the interior volume of each computer room into a hot zone and a cold zone, since the air cannot flow between the hot zone and the cold zone without passing through the computer cabinets,
the hot and respectively cold zones are superimposed one floor above the other,
each intermediate floor is perforated to allow free circulation of air, on the one hand, between the superimposed hot zones, and, on the other hand, between the superimposed cold zones, all superimposed cold zones forming a supply column of fresh air and all the superimposed hot zones forming an exhaust column of hot air,
the floors, the perimeter walls and interior walls are adapted to prevent a direct flow of air between the supply column and the exhaust column,
and the building comprises means for providing fresh air in the supply column and means for evacuating hot air from the exhaust column.

2. Building according to claim 1, wherein:
the peripheral walls of the computer rooms are superimposed and form a part of the load-bearing building structure,
and the interior walls are superimposed from one computer room to the other.

3. Building according to according to claim 1, wherein each computer room has a height of to 2 to 3 m and the building contains at least four floors of computer rooms.

4. Building according to according to claim 1, wherein each computer cabinet comprises partitions and/or at least partly removable partitions suited for obstructing the free flow of air in parts of the cabinet without computer hardware or electronics.

5. Building according to claim 1, comprising computer hardware or electronics disposed in at least one computer cabinet and adapted to draw in fresh air at a side facing the corresponding cold zone and to pump out warm air at a side facing the corresponding hot zone.

6. Building according to claim 1, wherein the surface, measured at floor level, of each cold zone is greater than or equal to the surface area, measured at floor level, of the corresponding hot zone.

7. Building according to claim 1, comprising at least one staircase and/or a lift for access to the computer rooms fitted outside the computer rooms.

8. Building according to claim 1, wherein the means of bringing fresh air and exhausting hot air comprise fresh air and hot air pipes connected to at least one air conditioning and/or air treatment installation.

9. Building according to claim 8, comprising under the lowest computer room at least:
a fresh air supply chamber which is separated from the cold area of the lowest room by a perforated floor allowing free air circulation and is connected to the air conditioning and/or air treatment installation,
a hot air exhaust chamber which is separated from the hot area of the lowest room by a perforated floor allowing free air circulation and is connected to the air conditioning and/or air treatment installation.

10. Building according to claim 9, wherein the air conditioning and/or treatment installation is located on the ground and/or basement.

11. Building according to claim 8, comprising at the level of or above the highest computer room at least:
a fresh air supply chamber which is separated from the cold area of the highest room by a perforated floor allowing free air circulation and is connected to the air conditioning and/or air treatment installation,
a hot air exhaust chamber which is separated from the hot area of the highest room by a perforated floor allowing free air circulation and is connected to the air conditioning and/or air treatment installation.

12. Building according to claim 11, wherein the air conditioning and/or treatment installation is located at the level of or above the highest computer room.

13. Building according to claim 1, wherein the means of bringing fresh air in comprise at least one exterior air intake vent at the cold zone level of the lowest computer room.

14. Building according to claim 13, wherein the means for evacuating hot air comprise at least one outlet vent open to the outside at the hot zone of the highest computer room.

15. Building according to claim 1, wherein the means for evacuating hot air comprise at least one outlet vent open to the outside at the hot zone of the highest computer room.

16. Building according to claim 13 or 14, wherein each vent is closed by at least one movable flap.

17. Process for regulating the temperature of the computer rooms of a building according to claim 1, wherein:
in an operating mode, called winter, when the outside air is at a temperature less than or equal to a limit or maximum recommended temperature, implementing the following steps:
evacuating part of the hot air from the hot air column to the outside,
taking outside air and mixing it with the remaining part of the hot air from the exhaust column to get fresh mixed air at a temperature within the recommended temperature range,
supplying the supply column with the mixed fresh air obtained,
in a operating mode, called mid-season, when the outside air is at a temperature above the limit or maximum recommended temperature and lower, the temperature of the air coming out of the computer or electronic equipment, implementing the following steps:
evacuating at least part of the hot air from the hot air column to the outside,
taking outside air and mixing it as needed with the remaining part of the hot air from the exhaust column to get fresh mixed air,
cooling the outside air or mixed air to obtain fresh air at a temperature within the recommended temperature range,
supplying the supply column with the mixed fresh air obtained,
in a operating mode, called summer, when the outside air is at a temperature above the temperature of the air coming out of the computer or electronic equipment, implementing the following steps:
completely recycling the hot air from the exhaust column,
cooling the recycled hot air to obtain recycled air at a temperature within the recommended temperature range,
supplying the supply column with the recycled fresh air obtained.

18. Process according to claim 17, wherein :
the means of bringing fresh air in comprise at least one exterior air intake vent at the cold zone level of the lowest computer room, the means for evacuating hot air comprise at least one outlet vent open to the outside at the hot zone of the highest computer room, each vent being closed by at least one movable flap,
it comprises a so-called economic mode to ensure the supply of air from the intake column and exhaust hot air from the exhaust column at least partly by natural convection by controlling the opening of inlet and outlet flaps.

19. Process according to claim 17, comprising a step of checking and adjusting the humidity of the air supplying to the supply column.

20. Process for regulating the temperature of the computer rooms of a building according to claim 17, wherein it ensures the supply of air from the supply column and exhaust hot air from the exhaust column at least partly by natural convection.

21. Process according to claim 17, wherein it comprises a step of air filtering.
